(19) United States
(12) Patent Application Publication
(10) Pub. No.: US 2021/0094879 A1
(43) Pub. Date: Apr. 1, 2021

(54) SELF-HEALING AND DURABLE CEMENT PASTE, MORTARS, AND CONCRETES

(71) Applicant: MASSACHUSETTS INSTITUTE OF TECHNOLOGY, Cambridge, MA (US)

(72) Inventors: Admir MASIC, Boston, MA (US); Linda SEYMOUR, Cambridge, MA (US)

(73) Assignee: MASSACHUSETTS INSTITUTE OF TECHNOLOGY, Cambridge, MA (US)

(21) Appl. No.: 17/048,474

(22) PCT Filed: Apr. 19, 2019
(86) PCT No.: PCT/US2019/028388

§ 371 Date: Oct. 16, 2020

Related U.S. Application Data
(60) Provisional application No. 62/660,057, filed on Apr. 19, 2018.
(60) Provisional application No. 62/792,890, filed on Jan. 15, 2019.

(51) Int. Cl. C04B 28/18; C04B 2/10

(52) U.S. Cl. CPC C04B 28/18; C04B 2/10

(57) ABSTRACT

Admixture for cementitious building materials can provide a self-healing mechanism to improve material longevity. In certain embodiments, the admixture can include the combination of both a quicklime-based replacement for fine and coarse aggregates and an SCM replacement for OPC in standard mortar and concrete.

### CLAIM OF PRIORITY

This application claims priority to U.S. Provisional Application No. 62/660,057, filed Apr. 19, 2018, U.S. Provisional Application No. 62/792,890, filed Jan. 15, 2019, each of which is incorporated by reference in its entirety.

### TECHNICAL FIELD

This invention relates to cement based construction material.

### BACKGROUND

Modern concrete infrastructure is susceptible to deterioration induced by mechanical, seismic, environmental and/or other stresses. As a result, concrete structures have a useful life of only around 100 years. This results in continued maintenance and reconstruction and a subsequent increased demand for ordinary Portland cement (OPC), of which 4,200 mega tons were produced globally in 2016. See U.S. Geological Survey, Minerals Information: Mineral Commodity Summaries (2017), (available at https://minerals.usgs.gov/minerals/pubs/mcs/index.html), which is incorporated by reference in its entirety. In addition to requiring the extraction of finite resources, production of OPC releases, on average, 0.7 tons CO₂ₑ emissions per ton produced. See G. P. Hammond, C. I. Jones, Embodied energy and carbon in construction materials. Proc. Inst. Civ. Eng.—Energy. 161, 87-98 (2008), which is incorporated by reference in its entirety. Besides the improved sustainability, self-healing and durable concrete solutions are highly desirable with respect to seismic excitation and other damages, such as microcracking, incurred during natural ageing or disasters.

### SUMMARY

In general, the compositions and methods of the invention feature a lime-based replacement for aggregate and, optionally, as a replacement for supplementary cementitious material for ordinary Portland cement.

In one aspect, a composition can include standard mortar including an ordinary Portland cement (OPC), a supplementary cementitious material (SCM), fine aggregate and calcined lime, wherein a portion of the OPC of an original formulation has been replaced with the supplementary cementitious material (SCM) and a portion fine aggregate of the original formulation has been replaced with the calcined lime.

In another aspect, a composition can include concrete including an ordinary Portland cement (OPC), a supplementary cementitious material (SCM), fine aggregate, coarse aggregate and calcined lime, wherein a portion of the OPC of an original formulation has been replaced with the supplementary cementitious material (SCM) and a portion fine aggregate of the original formulation has been replaced with the calcined lime.

In certain circumstances, the standard mortar can include 7-31 wt % of OPC and 69-93 wt % of fine aggregate.

In certain circumstances, up to 30% of OPC can be replaced with SCM.

In certain circumstances, up to 45% of fine aggregate can be replaced with calcined lime.

In certain circumstances, up to 25% of coarse aggregate can be replaced with calcined lime.

In certain circumstances, the SCM can include volcanic ash, fly ash, granulated blast furnace slag, silica fume, metakaolin, rice husk ash, calcined clay, brick, cocciopesto, or other ceramic materials.

In another aspect, a method of making an admixture for cementitious building materials can include making calcined lime by calcining calcium carbonate at temperatures between from 600° C. and 1450° C., crushing, grounding or milling and sieving the calcined lime, and retaining particles between 150 microns and 4 mm for admixture.

In certain circumstances, the method can include replacing fine aggregate with calcined lime up to 45% in standard mortar.

In certain circumstances, the method can include replacing OPC with SCM up to 30% in standard mortar.

In certain circumstances, the standard mortar can include 7-31 wt % of OPC and 69-93 wt % of fine aggregate.

In certain circumstances, the calcining calcium carbonate can be at temperatures between 600° C. and 750° C.

In certain circumstances, the calcining calcium carbonate can be at temperatures over 1300° C.

In certain circumstances, the fine aggregate can include quartz or sand.

Other aspects, embodiments, and features will be apparent from the following description, the drawings, and the claims.

### BRIEF DESCRIPTION OF THE DRAWINGS

FIG. 1 shows preliminary results utilizing lime calcined at various temperatures(BOTT) compared to Ordinary Portland cement (OPC). All samples were artificially aged to 28 days, fatigued by applying plastic deformation to the specimens, then continued curing in water at an elevated temperature to accelerate healing. Control samples were not fatigued but were cured in the same conditions.

FIG. 2 shows high resolution, quantitative EDS imaging of a fracture surface of 2000 years old Roman mortar revealing a remnant lime clast. EDS data mapped to ternary diagrams of (1) Ca/Si/Al and (2) Ca+Mg/Si/O for the entire image (grey), lime clast (red), coarse aggregate (purple), fine aggregate (blue) and cementitious binder (yellow). The lime clasts show a gradient in composition from the center to the exterior, suggesting the presence of a rim around the lime clasts.

FIGS. 3A-3D show the formation of bottacioli attributed to two pathways during the production of lime for Roman mortars due to the temperature gradient in the kiln (FIG. 3A). At temperatures near the onset of calcination (FIG. 3B), CaO or Ca(OH)₂ is protected by unreacted CaCO₃. At intermediate temperatures, this rim can be calcium-(alumina)-silica-hydrates or CaCO₃. At extremely high temperatures (FIG. 3C), sintering and subsequent passivation of the lime occurs, leaving it unreactive. Regardless of the mechanism, when cracks or degradation expose the bottacioli to water (FIG. 3D), the calcium is leached out and joins with unreacted pozzolanic material to form binder-like material or recrystallizes as CaCO₃.

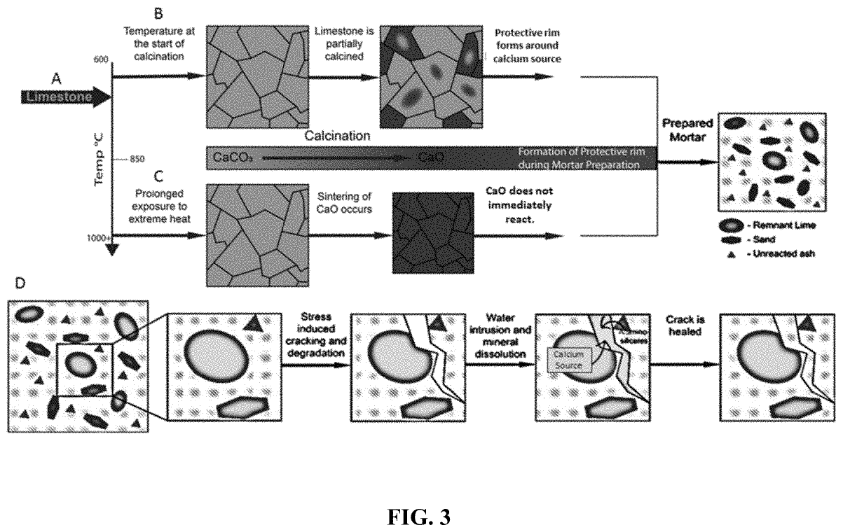

### DETAILED DESCRIPTION

Described herein are methods and compositions to improve the longevity of concrete, creating a more resilient building material by providing a source of calcium to react with water and crystallize in different forms in pores and microcracks caused by degradation, mechanical, seismic, environmental and/or other stresses. The primary degradation mechanisms which form these pores and cracks in OPC include chemical attack (especially by sulfates and chlorides), leaching and freeze thaw cycling and microfractures, cracking due to mechanical stresses. See H. F. W. Taylor, Cement chemistry (Thomas Telford Publishing, London, ed. 2, 1997; http://linkinghub.elsevier.com/retrieve/pii/S0958946598000237), which is incorporated by reference in its entirety. These avenues of attack induce spalling, loss of strength and material loss from the structure. Typically, chemical attack results in the formation of expansive crystals within the cementitious matrix that exert pressure on the surrounding material causing internal stresses that result in both cracking and spalling. Through leaching, the opposite occurs wherein material is slowly removed as rainwater or other agents flow over and through the material. As material is removed, porosity increases and this process is increasingly accelerated. A similar positive feedback loop exists in freeze-thaw cycling; as water enters the pore network and freezes, it expands exacerbating any cracking within the matrix. Other avenues for crack propagation include seismic activity, cyclic loading and other mechanical excitations. The solution to each of these degradation mechanisms is to fill the cracks and pores that form with a material of compatible chemical composition to ordinary Portland cement (OPC).

To this end, a source of calcium in various forms and amorphous silica, or pozzolana can be provided in order to fill cracks and pores caused by degradation with compatible calcium silica hydrates (CSH) and calcium silica aluminum hydrates (CASH) the primary binding agents within OPC. Aggregate scale grains of calcium carbonate and calcium oxide (CaO) replace fine aggregate (typically sand) in the concrete mixtures such that when cracks or pores intersect the grains, calcium in various forms is freed into the pore network, reacting with added pozzolanic material in order to fill the pores and cracks.

Current self-healing strategies in OPC based concrete fall into three primary categories: mineral, biological or adhesive based admixtures. Mineral admixtures include supplementary cementitious material (SCMs) which react with free lime in the OPC after a crack exposes the minerals to water. See M. Wu, B. Johannesson, M. Geiker, A review: Self-healing in cementitious materials and engineered cementitious composite as a self-healing material. Constr. Build. Mater. 28, 571-583 (2012), which is incorporated by reference in its entirety. Over time, both free lime and the SCMs react within the OPC as part of normal hydration in the matrix or carbonate, eliminating the viability as a self-healing mechanism. Geopolymer admixtures are also considered, however have similar shortcomings to that of SCMs, namely that the material can hydrate before cracking is even experienced. Biological self-healing strategies add CaCO₃ producing bacteria in capsules to the mixture in addition with a calcium containing salt or other calcium source. See S. van der Zwagg, Self Healing Materials An Alternative Approach to 20 Centuries of Materials Science (2007), which is incorporated by reference in its entirety. Upon cracking, the capsule releases the bacteria which then fill in the crack with CaCO₃. See V. Wiktor, H. M. Jonkers, Quantification of crack-healing in novel bacteria-based self-healing concrete. Cem. Concr. Compos. 33, 763-770 (2011), and C. Stuckrath, R. Serpell, L. M. Valenzuela, M. Lopez, Quantification of chemical and biological calcium carbonate precipitation: Performance of self-healing in reinforced mortar containing chemical admixtures. Cem. Concr. Compos. 50, 10-15 (2014), each of which is incorporated by reference in its entirety. The viability of this mechanism exists as long as the bacteria survive. Adhesive based strategies rely on capsules of resin that, when a crack intersects with the capsule, fill in the space created. See H. Huang, G. Ye, C. Qian, E. Schlangen, Self-healing in cementitious materials: Materials, methods and service conditions. Mater. Des. 92, 499-511 (2016), which is incorporated by reference in its entirety. For two-component epoxies, this process can result in uneven mixing and single component epoxies typically cure via air exposure so the presence of water can be problematic.

Ordinary Portland cement based concretes are the primary construction material in civil infrastructure. Without additives, the brittle material is susceptible to cracking allowing water intrusion that expedites degradation. Current admixtures include pozzolanas (e.g. fly ash, granulated blast furnace slag), encapsulated bacteria and epoxy capsules.

In order to be viable, admixtures for durability must survive the highly basic environment of OPC and be available for the service life of the structure (e.g. decades). For this reason, current admixtures tend to be most effective in early-age concrete either due to material viability or ongoing hydration reactions with the cement.

Standard mortar contains 7-31 wt % of OPC, 69-93 wt % of fine aggregate and 0% of coarse aggregate. Standard concrete contains 10-20% of OPC, 30-40% of fine aggregate and 45-60% of coarse aggregate. Herein, fine aggregates are particles between 150 microns and 4 mm in size. Coarse aggregates are particles greater than 4 mm.

Herein, Supplementary Cementitious Materials (SCM) are materials having pozzolanic activity when mixed with OPC. SCM includes volcanic ash, fly ash, granulated blast furnace slag, silica fume, metakaolin, rice husk ash, calcined clays, brick, cocciopesto, and other ceramic materials.

The composition described herein partially replaces up to 45% of the fine aggregates in mortar mixtures with calcined and/or partially calcined calcium carbonate limestone (or any geological and man-made equivalent). In addition, up to 30% of ordinary Portland cement is replaced with an SCM such as volcanic ash, fly ash, silica fume, granulated blast furnace slag or other pozzolanic material. In concrete mixtures coarse aggregates can also be replaced up to 25% with the calcined lime.

The method disclosed herein is hinged on the combination of both a lime-based replacement for the aggregate and an SCM replacement for OPC. In certain embodiments, calcined lime is made by calcining calcium carbonate at temperatures ranging from 600° C. (under calcined) to 1450° C. (sintered). Preferably, lime can be calcined between 600° C. and 750° C. or over 1300° C. The resulting calcined lime can be crushed, ground or milled and sieved, and particles between 150 microns and 4 mm are retained for admixture replacement of fine aggregates. If coarse aggregates are to be substituted with quicklime, particles greater than 4 mm are retained. In certain embodiments fine aggregate (e.g. quartz, sand) can be replaced with calcined lime up to 45% in standard mortar and OPC can be replaced with SCM up to 30% in standard mortar. Calcined lime clasts in this invention are not slaked (submerged in water) prior to adding into the cement mixture (both mortar and concrete mix). The heat from the quicklime hydration once water is added to the mixture is critical to the development of a protective rim around the calcined lime clasts (hot mixing).

Lime can be obtained from limestone, dolomitic limestone, marble and any other sources of calcium carbonate (CaCO₃).

The primary advantages of this system is that it is applicable to both aerial and marine infrastructure, utilizes universally available materials and does not require new production technology for the cement industry. The healing process observed can be obtained via both hydration reactions to form binder-like and recrystallization of CaCO₃ through wetting and drying cycles. SCMs are gaining traction as mainstream additives in OPC and the addition of calcined limestone does not require the creation of new production equipment or strategies within the industry. Because the calcined limestone is replacing aggregate, it can be added during production or in post-production at the site of application. The ubiquity of limestone and the array of SCMs suitable for this application make this a viable solution in a diverse array of geographic locations.

This solution is inspired by the durability of Roman concrete which is primarily studied for historical perspectives, not to inspire new materials. Due to the material's multi-scale heterogeneity and the complex nature of cementitious materials, characterization of Roman concrete has remained difficult. See M. D. Jackson et al., Phillipsite and Al-tobermorite mineral cements produced through low-temperature water-rock reactions in Roman marine concrete. Am. Mineral. 102 (2017), and T. Schmid, P. Dariz, Chemical imaging of historical mortars by Raman microscopy. Constr. Build. Mater. 114, 506-516 (2016), each of which is incorporated by reference in its entirety. High resolution characterization techniques were implemented, including scanning electron microscopy—energy dispersive x-ray spectroscopy (SEM-EDS) of fresh fracture surfaces not yet observed. The data-analysis techniques allowed comparison of 262,144 micron-scale data points per EDS image to evaluate the composition of remnant lime in 2,000-year-old samples. The high-resolution techniques allowed us to explore the viability of the remnant lime as a supplier of calcium in a long term self-healing mechanism activated by the propagation of micro-cracks within the cementitious material. Understanding how Roman mortars and concretes have lasted for millennia was the key inspiration for this solution.

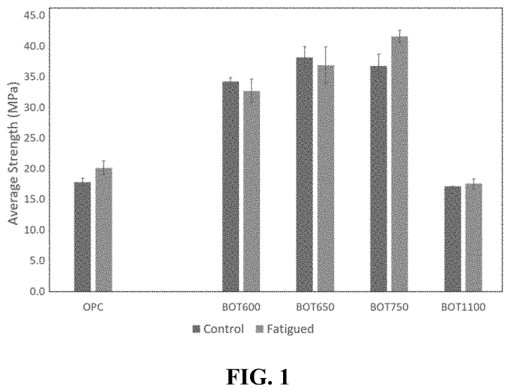

In FIG. 1, samples were artificially aged to 28 days, fatigued (if applicable) by applying plastic deformation to the specimens, then continued curing in water at an elevated temperature to accelerate healing. Control samples were not fatigued but were cured in the same conditions. See Table 1 for mix compositions.

TABLE 1
Mix compositions for initial testing indicating the
amount of OPC replaced by pozzolana and the amount
of fine aggregate (sand) replaced by calcined lime.

| Mix | % OPC | % Aggregate | Temperature |
|---|---|---|---|
| Identifier | Replaced | Replaced | of calcination |
| OPC | 0 | 0 | N/A |
| BOT600 | 20 | 25 | 600 |
| BOT650 | 20 | 25 | 650 |
| BOT750 | 20 | 25 | 750 |
| BOT1100 | 20 | 25 | 1100 |

In order to enforce this invention, the large area EDS phase chemical maps on polished thin-sections of the samples in question should be collected. The EDS spectrum quantifies the total number of X-rays emitted and their energies, describing the elemental composition of the measured spot. Using this technique 16-bit greyscale quantitative images with pixel brightness values indicating the amounts of calcium, silicon and aluminum present at each pixel location for each EDS dataset can be used to plot the ratios of those elements for all pixels in that sample's dataset on ternary density plots and ternary frequency diagrams. In the ternary density plots, the ratios of calcium to silicon to aluminum at each pixel in the measured area is represented by a single point on the ternary diagram. Ternary density plots extend the visualization of the vast amounts of data obtained EDS by showing the distribution of the points on the ternary diagram. Ternary frequency diagrams are particularly useful in detecting the primary phases such as traces of carbonated, unreacted and free lime (CaCO₃/Ca(OH)₂/CaO) compared to cementitious calcium-alumina-silica-hydrate phases present in the sample being measured, which are key phases of this invention. This approach allows precise identification, in terms of type of phases present as well as the mix design.

This invention is based on the following observations in Roman mortar and concrete. Having proven longevity on the order of millennia, it is an attractive model system for the design of sustainable, durable solutions for the future. For many centuries throughout the entire ancient Roman empire, architectural elements, such as walls, foundations and aqueducts, were shaped by pouring a concrete mainly composed of volcanic tuff and coarse aggregates (caementa) bound by a hydraulic volcanic ash—lime-based mortar. See Vitruvius Pollio., F. Granger, On architecture [electronic resource] translated by Frank Granger (Harvard University Press, Cambridge, 1931; https://www.loebclassics.com/view/LCL251/1931/volume.xml), which is incorporated by reference in its entirety. Often, especially in applications in which water interacts with the construction material, such as in baths and aqueducts, the volcanic ash binder was substituted or mixed with fine-ground brick powder (cocciopesto). In recent years, advanced studies of ancient mortars and concretes in both architectural and maritime settings allowed for the identification of some of the key chemical and mineralogical processes associated with volcanic ash-hydrated lime interactions, and provided insights into the mechanical durability of these materials. See M. D. Jackson et al., Unlocking the secrets of Al-tobermorite in Roman seawater concrete. Am. Mineral. 98, 1669-1687 (2013), M. D. Jackson et al., Phillipsite and Al-tobermorite mineral cements produced through low-temperature water-rock reactions in Roman marine concrete. Am. Mineral. 102 (2017) (available at http://ammin.geoscienceworld.org/content/102/7/1435), J. Elsen, O. Cizer, R. Snellings, Lessons from a lost technology: The secrets of Roman concrete. Am. Mineral. 98, 1917-1918 (2013), M. D. Jackson et al., Mechanical resilience and cementitious processes in Imperial Roman architectural mortar. Proc. Natl. Acad. Sci. U.S.A. 111, 18484-9 (2014), and C. Brandon, R. Hohlfelder, M. Jackson, J. Oleson, Building for eternity: the history and technology of Roman concrete engineering in the sea (Oxbow Books, 2014), each of which is incorporated by reference in its entirety. Conclusive studies focusing on the durability of the Roman concrete in marine environments evidenced the dissolution of lime and vitric tuff clasts at high pH, followed by the precipitation of calcium-aluminum silicate hydrates (CASH) in perimetral rinds, and consequent crystallization of tobermorite in the clasts. See M. D. Jackson et al., in Historic Mortars (Springer Netherlands, Dordrecht, 2012; http://www.springerlink.com/index/10.1007/978-94-007-4635-0_5), pp. 49-76, which is incorporated by reference in its entirety. Relict lime clasts (also known as bottaccioli) are a ubiquitous feature of both architectural and maritime Roman cement, and they are formed when the lime putty is not completely slaked during cement production. See Vitruvius Pollio., F. Granger, On architecture [electronic resource] translated by Frank Granger (Harvard University Press, Cambridge, 1931; https://www.loebclassics.com/view/LCL251/1931/volume.xml), which is incorporated by reference in its entirety. Bottacioli are heterogeneous in composition; they may contain portlandite (Ca(OH)₂), calcite, vaterite, brucite, and Al-tobermorite. Although these clasts are well characterized in the maritime Roman concrete (see Jackson et al. and references therein), the following observation on composition of relict lime clasts in open air Roman constructions, indicates that they play a role in architectural mortar longevity as well. See C. Brandon, R. Hohlfelder, M. Jackson, J. Oleson, Building for eternity: the history and technology of Roman concrete engineering in the sea (Oxbow Books, 2014), which is incorporated by reference in its entirety.

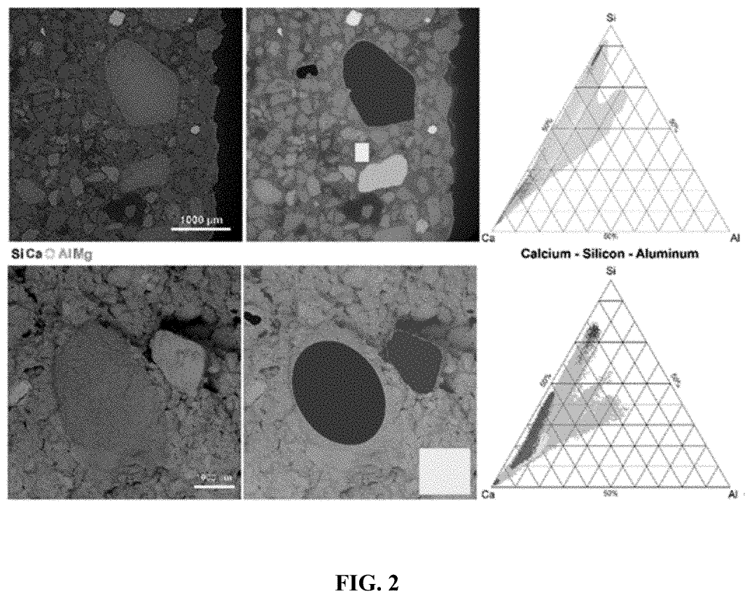

The chemical characteristics of lime clasts found in 2000-year-old Roman concrete samples obtained from the archaeological site of Privernum (Italy) are characterized using large-area, quantitative SEM/EDS imaging (FIG. 2). A self-healing mechanism can explain durability and high resiliency of this ancient building material.

The chemical images in FIG. 2 were collected using high resolution SEM and multi-detector EDS in conjunction with quantitative mapping to explore the chemistry of the lime clasts in two modes: within a polished cross-section (top) and on a freshly fractured surface (bottom), with the aim of understanding its viability as a source of calcium for a self-healing mechanism in the mortar. Quantitative maps were generated for calcium, silicon, and aluminum, and the ratios were computed for each pixel of the 512 by 512 pixel dataset. The ratios of calcium to silicon to aluminum were plotted on ternary diagrams, as shown in FIG. 2 (top and bottom right).

The polished cross section showed two lime clasts, illustrated in red and green, each appearing in a different location on the Ca+Mg−Si−Al phase diagram (FIG. 2 top). These differences are attributed to the partial reaction of the lime upon inclusion in the mortar.

To determine whether the process of embedding and polishing the samples had an effect on the ratios obtained from the EDS datasets, this analysis was also conducted using quantitative EDS maps of a fractured surface of Roman concrete (FIG. 2 bottom). Here, it is evident that center of the clast is calcium dominated.

Previous evidence suggests that in maritime structures, the remnant lime reacts in place forming both amorphous (CASH) and crystalline phases (Al-tobermorite). See M. D. Jackson et al., Phillipsite and Al-tobermorite mineral cements produced through low-temperature water-rock reactions in Roman marine concrete. Am. Mineral. 102 (2017) , which is incorporated by reference in its entirety. However, this is not the case in this mortar obtained from an aerial structure (FIG. 2—Ca—Si—Al diagrams). While the polished cross section shows clear inclusion of silicon and aluminum in the lime clast indicating that some conversion to CASH or Al-tobermorite has occurred, there remains enough active calcium to keep the region bound to the calcium corner of the phase diagram. The conversion of the calcium to aluminosilicate compounds does not occur within these lime clasts of architectural structures as readily as it does within maritime structures. In fact, regions of binder higher in calcium than the rest of the matrix can be seen trailing from the lime clast to areas of recrystallization along the outside of the fragment. The recrystallization phase shows ratios of silicon and aluminum approaching that of the original binder but still likely dominated by calcium carbonate.

The remnant lime clasts within Roman mortar serve as a source of calcium for a pore-and crack-filling mechanism combats its degradation over time. Over time, as cracks and pores form, the intrusion of water causes the dissolution of calcium from the clasts, carrying it into the pore network where it can either react with aluminosilicates forming more binder-like material or crystallize as calcium carbonate. This self-healing could be the result of many different scenarios that may occur during the mortar production, specifically as the limestone is calcined to form quicklime (CaO). The temperature gradient within the kiln results in varying levels of calcination of the limestone. In the first scenario, extreme temperatures, up to 1300° C., for prolonged periods of time result in the sintering of the resulting calcium carbonate, passivating it in the process. See R. H. Borgwardt, Sintering of nascent calcium oxide. Chem. Eng. Sci. 44, 53-60 (1989), and J. Válek et al., Determination of optimal burning temperature ranges for production of natural hydraulic limes. Constr. Build. Mater. 66, 771-780 (2014), each of which is incorporated by reference in its entirety. In the second scenario, at lower temperatures just below and at the calcination temperature, the limestone is converted to a heterogeneous mixture of both calcium oxide and calcium carbonate. In all cases, and independently from the temperature at which the CaO is produced, the exterior of quicklime starts hydration process through an exothermic process that generate conditions for producing a protective shell that passivates the lime. In all these situations, the protected calcium is integrated into the mortar, and upon cracking or other degradation (e.g. pore formation), it provides the primary mechanism to repair the matrix.

As the remnant calcium is leached into the cracks or pores via water intrusion, many different pathways exist for healing. For example, excess pozzolanic material, such as volcanic ash that did not react during the initial setting, can now react to form calcium-silica-hydrates, filling in the space with more binder-type material. In the absence of such pozzolana, the recrystallization of the calcium within the pore space as calcite can also occur. The latter pathway, in which secondary calcium carbonate is precipitated, relies on the wetting and drying cycles experienced in normal weather conditions. Both avenues are suggested by the recrystallization phase (purple) identified in FIG. 2 which lies primarily near the calcium carbonate region of the ternary phase diagrams, but has aluminum and silica ratios drawing it close to of ternary diagram region of the original binding phase (yellow).

The entire process acts as a self-healing system for the Roman mortar, occurring upon stimulation from external forces that would otherwise cause material failure if left unchecked. The lime remains protected until it is needed, thus allowing the healing nature of this process to persist even after millennia. The self-healing properties of ancient Roman mortar are somehow fortuitous and fruit of the ancient technology they used to produce mortar and cement mixes. It is this knowledge on mixing that we then implement in modern mortars and concretes for the invention described herein.

Other embodiments are within the scope of the following claims.

1. A composition comprising:
standard mortar including an ordinary Portland cement (OPC), a supplementary cementitious material (SCM), fine aggregate and calcined lime, wherein a portion of the OPC of an original formulation has been replaced with the supplementary cementitious material (SCM) and a portion fine aggregate of the original formulation has been replaced with the calcined lime.

2. The composition of claim 1, wherein the standard mortar includes 7-31 wt % of OPC and 69-93 wt % of fine aggregate.

3. The composition of claim 2, wherein up to 30% of OPC is replaced with SCM.

4. The composition of claim 2, wherein up to 45% of fine aggregate is replaced with calcined lime.

5. The composition of claims 1, wherein the SCM includes volcanic ash, fly ash, granulated blast furnace slag, silica fume, metakaolin, rice husk ash, calcined clay, brick, cocciopesto, or other ceramic materials.

6. A method of making an admixture for cementitious building materials comprising:
making calcined lime by calcining calcium carbonate at temperatures between from 600° C. and 1450° C.;
crushing, grounding or milling and sieving the calcined lime; and
retaining particles between 150 microns and 4 mm for admixture.

7. The method of claim 6, further comprising replacing fine aggregate with calcined lime up to 45% in standard mortar.

8. The method of claim 6, further comprising replacing OPC with SCM up to 30% in standard mortar.

9. The method of claim 7, wherein the standard mortar includes 7-31 wt % of OPC and 69-93 wt % of fine aggregate.

10. The method of claim 6, calcining calcium carbonate at temperatures between 600° C. and 750° C.

11. The method of claim 6, further comprising calcining calcium carbonate at temperatures over 1300° C.

12. The method of claim 6, wherein fine aggregate includes quartz or sand.

13. A composition comprising:
concrete including an ordinary Portland cement (OPC), a supplementary cementitious material (SCM), fine aggregate, coarse aggregate and calcined lime, wherein a portion of the OPC of an original formulation has been replaced with the supplementary cementitious material (SCM) and a portion fine aggregate of the original formulation has been replaced with the calcined lime.

14. The composition of claim 13, wherein the concrete includes 7-31 wt % of OPC and 69-93 wt % of fine aggregate.

15. The composition of claim 14, wherein up to 30% of OPC is replaced with SCM.

16. The composition of claim 13, wherein up to 45% of fine aggregate is replaced with calcined lime.

17. The composition of claim 13, wherein up to 25% of coarse aggregate is replaced with calcined lime.

18. The composition of claim 13, wherein the SCM includes volcanic ash, fly ash, granulated blast furnace slag, silica fume, metakaolin, rice husk ash, calcined clay, brick, cocciopesto, or other ceramic materials.

19. The method of claim 8, wherein the standard mortar includes 7-31 wt % of OPC and 69-93 wt % of fine aggregate.
